(19) United States
(12) Patent Application Publication
(10) Pub. No.: US 2016/0080101 A1
(43) Pub. Date: Mar. 17, 2016

(54) METHOD AND APPARATUS FOR MITIGATING INTERFERENCE

(71) Applicant: NOKIA CORPORATION, Espoo (FI)

(72) Inventors: Hossein Ali Safavi NAEINI, Schererville, IN (US); Rapeepat RATASUK, Hoffman Estates, IL (US); Eugene VISOTSKY, Buffalo Grove, IL (US); Sayantan CHOUDHURY, Berkeley, CA (US)

(21) Appl. No.: 14/485,263

(22) Filed: Sep. 12, 2014

(51) Int. Cl. H04J 11/00; H04B 1/10

(52) U.S. Cl. CPC H04J 11/005; H04B 1/1036

(57) ABSTRACT

A method and apparatus can be configured to receive an input. The input comprises a plurality of values. The receiver receives the input in the presence of interference caused by another system. The method may also include determining the values that have been affected by the interference. The method may also include mitigating the effects of the interference upon the received input.

### BACKGROUND

1. Field

Embodiments of the invention relate to mitigating interference.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include receiving, by a receiver, an input. The input may include a plurality of values. The receiver may receive the input in the presence of interference caused by another system. The method may also include determining the values that have been affected by the interference. The method may also include mitigating the effects of the interference upon the received input.

In the method of the first embodiment, the interference may be caused by a radar system.

In the method of the first embodiment, receiving the values may include receiving at least one of log likelihood ratios, soft decisions, I/Q values, pre-equalization values, post-equalization values, pre-Fast-Fourier-Transform values, post-Fast-Fourier-Transform values, and post-processing values.

In the method of the first embodiment, the determining the values that have been affected by the interference may include determining values that are abnormal.

In the method of the first embodiment, the determining the values that have been affected by the interference may include calculating an average value and a standard deviation of the values.

In the method of the first embodiment, the determining the values that have been affected by the interference may include comparing the values to a threshold.

In the method of the first embodiment, the mitigating the effects of the interference may include replacing the values that have been determined to have been affected by the interference.

In the method of the first embodiment, the replacing the values may include replacing the values with zeros.

According to a second embodiment, an apparatus may include at least one processor. The apparatus may also include at least one memory including computer program code. The at least one memory and the computer program code may be configured, with the at least one processor, to cause the apparatus at least to receive an input. The input may include a plurality of values. The apparatus may receive the input in the presence of interference caused by another system. The apparatus may also be caused to determine the values that have been affected by the interference. The apparatus may also be caused to mitigate the effects of the interference upon the received input.

In the apparatus of the second embodiment, the interference may be caused by a radar system.

In the apparatus of the second embodiment, receiving the values may include receiving at least one of log likelihood ratios, soft decisions, I/Q values, pre-equalization values, post-equalization values, pre-Fast-Fourier-Transform values, post-Fast-Fourier-Transform values, and post-processing values.

In the apparatus of the second embodiment, the determining the values that have been affected by the interference may include determining values that are abnormal.

In the apparatus of the second embodiment, the determining the values that have been affected by the interference may include calculating an average value and a standard deviation of the values.

In the apparatus of the second embodiment, the determining the values that have been affected by the interference may include comparing the values to a threshold.

In the apparatus of the second embodiment, the mitigating the effects of the interference may include replacing the values that have been determined to have been affected by the interference.

In the apparatus of the second embodiment, the replacing the values may include replacing the values with zeros.

According to a third embodiment, a computer program product may be embodied on a non-transitory computer readable medium. The computer program product may be configured to control a processor to perform a process including receiving, by a receiver, an input. The input may include a plurality of values. The receiver may receive the input in the presence of interference caused by another system. The process may also include determining the values that have been affected by the interference. The process may also include mitigating the effects of the interference upon the received input.

In the computer program product of the third embodiment, the interference may be caused by a radar system.

In the computer program product of the third embodiment, receiving the values may include receiving at least one of log likelihood ratios, soft decisions, I/Q values, pre-equalization values, post-equalization values, pre-Fast-Fourier-Transform values, post-Fast-Fourier-Transform values, and post-processing values.

In the computer program product of the third embodiment, the determining the values that have been affected by the interference may include determining values that are abnormal.

In the computer program product of the third embodiment, the determining the values that have been affected by the interference may include calculating an average value and a standard deviation of the values.

In the computer program product of the third embodiment, the determining the values that have been affected by the interference may include comparing the values to a threshold.

In the computer program product of the third embodiment, the mitigating the effects of the interference may include replacing the values that have been determined to have been affected by the interference.

In the computer program product of the third embodiment, the replacing the values may include replacing the values with zeros.

### BRIEF DESCRIPTION OF THE DRAWINGS

For proper understanding of the invention, reference should be made to the accompanying drawings, wherein:

FIG. 1 illustrates an impact of operating a radar on confidence levels for predicted bits.

FIG. 2 illustrates the benefits of selective erasures on throughput when encountering radar interference, in accordance with certain embodiments of the present invention.

FIG. 3 illustrates an erasing algorithm in accordance with certain embodiments of the present invention.

FIG. 4 illustrates performing detection and rate selection in accordance with embodiments of the present invention.

FIG. 5 illustrates a flowchart of a method in accordance with embodiments of the present invention.

FIG. 6 illustrates an apparatus in accordance with embodiments of the present invention.

FIG. 7 illustrates an apparatus in accordance with embodiments of the present invention.

### DETAILED DESCRIPTION

Embodiments of the invention relate to mitigating interference. For example, certain embodiments of the present invention may be directed to mitigating the effects of burst interference upon soft decoders by using outlier detection and erasures.

Wireless networks may rely on coding and decoding to introduce redundancy in transmitted data. By introducing redundancy into transmitted data, the wireless network may reduce an amount of lost or corrupted information when erroneous signal reception occurs. In effect, a transmitter may send data with additional redundancy, such as repeated bits, for example.

The additional redundancy may be used to detect and correct errors at a receiver. The decoder at the receiver may take the received bits (which include the redundancy), and the decoder may attempt to recover the original data which was transmitted by the transmitter. Additional redundancy may take the form of repeated bits or additional bits that may be used to detect/correct errors. For example, a 10-bit message may be accompanied by 10 bits of redundancy.

In advanced receivers, such as LTE receivers, the input to the decoder may include a best guess (an estimation) as to what each received bit was (either a “1” or a “0,” for example), and the input may also include a level of confidence in that guess/estimation. The confidence levels may be considered to be “soft information,” as described in more detail below. The input may take the form of a Log Likelihood Ratio (LLR). With LLRs, large negative values reflect high confidence that the received bit is a “0,” and large positive values reflect the high confidence that the value of the received bit is a “1.” As such, LLRs that are close to “0” may correspond to a high degree of uncertainty in the value of the bit.

In general, LTE networks have been deployed in exclusive bands that are not shared with any other types of wireless devices or networks. However, recently, governments and spectrum regulators have begun considering a shared access scheme between LTE and Radar systems. As a result, engineering efforts are being directed to minimizing the negative impact of radar interference upon LTE communication. By minimizing the negative impact of radar interference, the high performance that is expected from such LTE/4G networks may be retained.

However, the algorithms that are employed in current LTE systems may not be well-designed/adapted to mitigate radar interference. In particular, the current LTE systems may not be well-designed/adapted to mitigate powerful short duration-burst interference. Power short duration-burst interference may result in the course of operating certain radar systems. Based upon simulation data, it has been determined that soft information may be negatively affected, and the affected soft information may be susceptible to indicating mistaken certainty of bits, when used in the presence of radar interference. Soft information may include LLRs, received In-phase/Quadrature (I/Q) values or samples, pre or post-equalization values, pre or post-FFT values, and/or post-processing values, for example.

Such mistaken/false certainty (caused by the effects of interference) may be propagated through the decoder of the receiver, and the mistaken/false certainty may cause certain transmitted data to be unrecoverable, even in cases where the data only has a small number of bits in error.

As described above, LTE technology has generally been deployed and operated as an exclusive user/owner of a spectrum (for example, LTE networks were generally not co-deployed with any other devices in the same band). Therefore, there generally have not been efforts directed to mitigating the type of interference that is posed by radars.

In WiFi, dynamic frequency selection may be required in bands with possible radar interference. In this case, when a WiFi node detects radar transmissions, the WiFi node generally vacates the channel. Thus, with WiFi, there is generally no attempt to coexist with radar interference.

In contrast with the above-described approaches, certain embodiments of the present invention are directed to a method for mitigating an impact of interference. Embodiments of the present invention may mitigate an impact of radar interference on an LTE soft decoder. The method may include computing statistics relating to a transmission. For example, the method may include computing statistics relating to LLRs (i.e., the predicted bit confidence values) or symbols at the LTE receiver. The method may also include locating outliers (such as abnormally high confidence values). The method may also include erasing/replacing bits or symbols that correspond to abnormal/outlier confidence values.

Certain embodiments of the present invention may provide improved throughput for LTE systems, in the presence of radar interference. Certain embodiments of the present invention may also perform detection of radar interference in shared bands using outlier LLRs or symbols. Certain embodiments of the present invention may also perform rate selection. Certain embodiments of the present invention may facilitate transmit rate selection based on a number of observed erasures/replacements. Transmit rate selection is generally considered to be a method by which a base station will select how much redundancy to include and how robust the signal should be. Based on measurement of noise/channel conditions/interference, the base station may decide that using more redundancy is necessary so that the message can be reliably decoded. Likewise, the base station may decide that the conditions are good enough to warrant less redundancy and more aggressive (higher) bit rates. This process may be referred to as rate selection.

Principles of certain embodiments of the present invention may be used to modify outliers at other stages of a receiver chain as well (such as used to perform pre-equalization or post-equalization, for example). Furthermore, the techniques of certain embodiments of the present invention may be used to mitigate other types of strong interference that have limited duration.

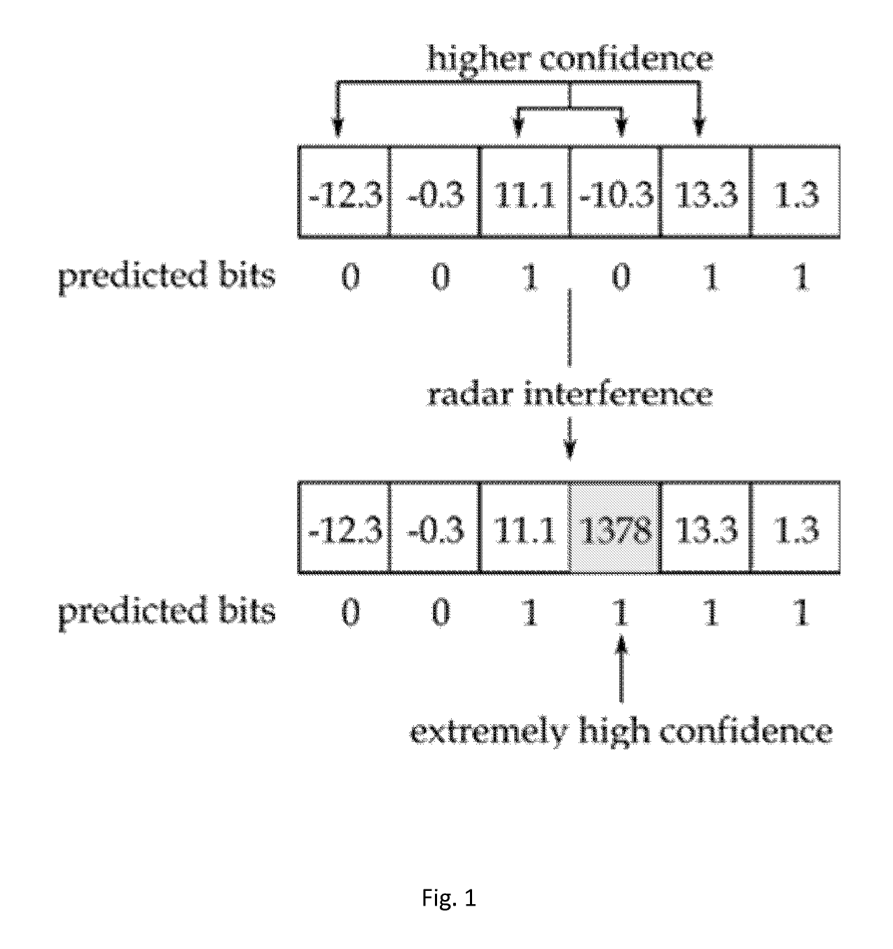

FIG. 1 illustrates an impact of operating a radar on confidence levels for predicted bits. FIG. 1 illustrates an impact of burst interference on LLR values for a string of bits. As illustrated by FIG. 1, the fourth bit in the sequence experiences burst interference, which results in a dramatic change in the LLR value (from −10.3 to 1378). In addition to flipping the predicted bit from “0” to “1,” the flipped value may correspond to an extremely high confidence. The magnitude of the LLR may be abnormally large in relation to the LLRs of the other bits.

To correct the effects of such interference, certain embodiments of the present invention may perform the following steps. Certain embodiments may compute an average of the LLR magnitudes as follows:

LLR_{avg}=average(LLR_{magnitudes})

Certain embodiments of the present invention may compute a standard deviation of the LLR magnitudes:

LLR_{std}=std.deviation(LLR_{magnitudes})

Embodiments of the present invention may erase/replace LLRs that exceed a certain level of confidence in relation to the average and standard deviation by setting these LLRs to zero. For example, embodiments of the present invention may set the LLR to zero for any bit i that matches the following condition:

|LLRᵢ|>LLR_{avg}+η×LLR_{std},

where η is a positive parameter determined through simulations and experimentation.

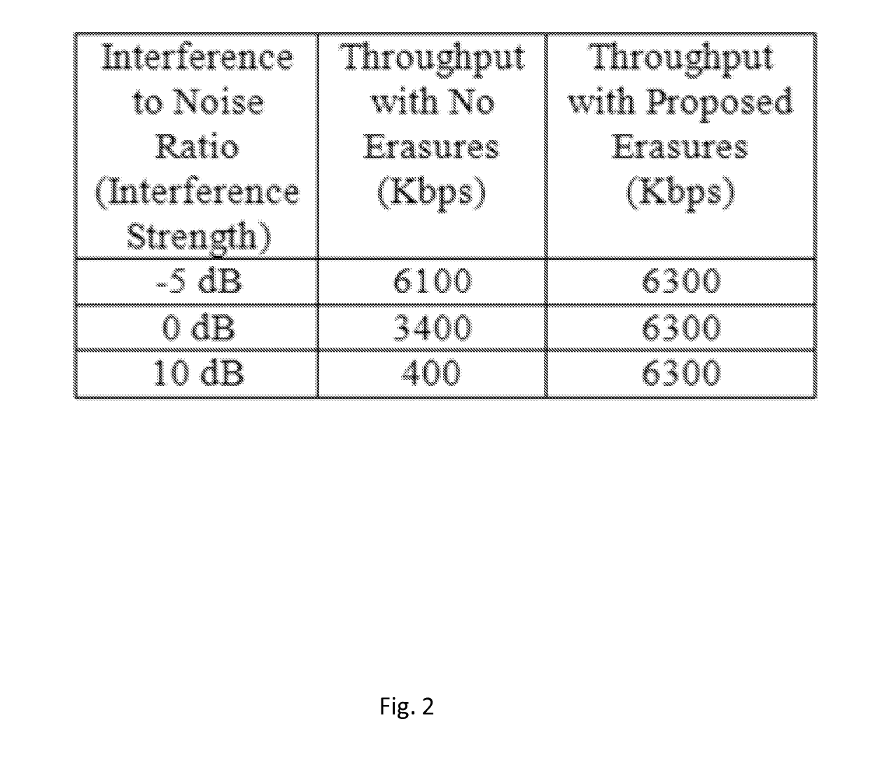

FIG. 2 illustrates the benefits of selective erasures on throughput when encountering radar interference, in accordance with certain embodiments of the present invention. In one embodiment of the present invention, the LLR values of bits near bits with abnormally high LLR values may also be nulled (i.e., set to zero). The bits (which are near bits with abnormally high LLR values) may correspond to bits that were transmitted at or near the same time as when the abnormally high LLR values were transmitted, for example. FIG. 2 compares a throughput of a system that implements embodiments of the present invention against a throughput of another system that does not implement embodiments of the present invention.

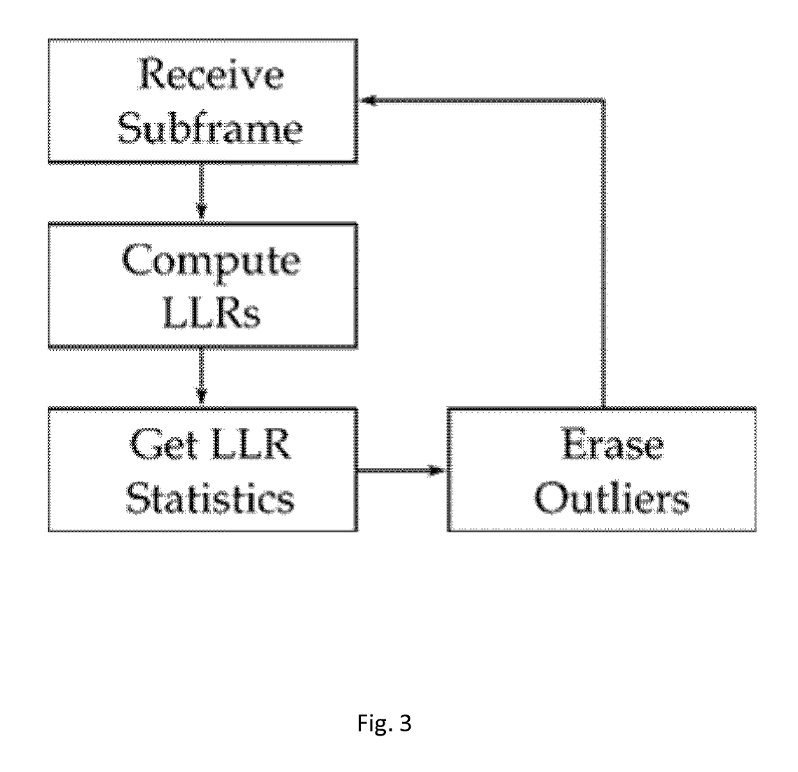

FIG. 3 illustrates an erasing algorithm in accordance with certain embodiments of the present invention. A decoder/receiver may receive input (the input may be in the form of a subframe, for example). LLRs for the bits of the input may be computed. In one embodiment, the receiver may compute the LLR values. For a given bit, the LLR may be computed as:

$$L L R = log ( \frac{Pr ( bit is 1 )}{Pr ( bit is 0 )} )$$

The LLR may be the receiver's opinion of the likelihood of a received bit being a 1 or 0. Referring to the equation above, the Pr(.) signifies probability. The specific mathematical expression for the probability may depend on estimates of the noise and interference measured by the base station.

Certain LLR statistics may then be calculated. By using the LLR statistics, embodiments of the present invention may be able to categorize certain LLRs or bits as outliers to be erased. These outliers may then be erased. With regard to radar detection, the observed LLR statistics may be used to detect the presence of radar interference or to estimate simple parameters. The simple parameters may include a periodicity of radar pulses. When a receiver encounters abnormal (such as large) LLR values, these values may be taken as an implicit indication that specific bits have been subjected to radar interference.

With regard to rate selection, by recording the number of erasures triggered due to the abnormal LLRs, a code rate of the transmitted signal may be adjusted for additional redundancy so that the erasures do not negatively impact the decoding process. For example, if N erasures occur based on the LLRs, a code rate may be selected that is able to tolerate these additional erasures. The code rate may be a ratio of “useful” bits to the total bits transmitted. For example, a code rate of ⅓ may mean that for every 1 useful bit, 2 redundant bits are transmitted. The transmitter adjusts the code rate based on its error target and channel measurements. If the channel quality is bad, the transmitter may lower the rate so that more redundant bits are transmitted and the message is more resilient to errors.

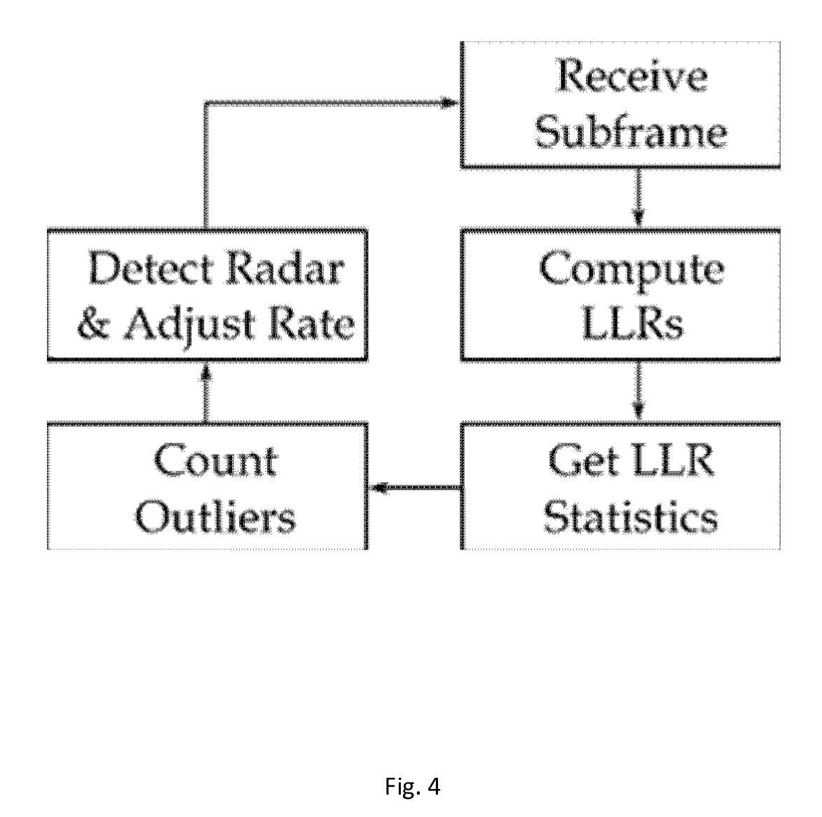

FIG. 4 illustrates performing detection and rate selection in accordance with embodiments of the present invention. Certain embodiments of the present invention may receive input, may compute LLRs, and get LLR statistics. As described above, the number of outlier LLRs/bit-values may be counted, and the presence of radar interference may be detected. A code rate may then be adjusted. In view of the above, embodiments of the present invention may improve throughput and decoding ability for receivers.

The algorithms of certain embodiments of the present invention may enable improved performance in LTE, when LTE technologies are utilized in the presence of strong interference of limited duration. Having LTE technologies coexist with radar interference is of interest to network operators because a large amount of bandwidth may be available for LTE deployment, if the obstacles which entail can be resolved. If LTE cannot properly coexist with radar interference, the alternative is to evacuate the spectrum whenever a radar is present. Another alternative is to use an exclusion zone that prohibits LTE deployment in bands with potential radar interference.

The algorithm of certain embodiments of the present invention may be utilized by user equipment (UE) and/or evolved Node B (eNB).

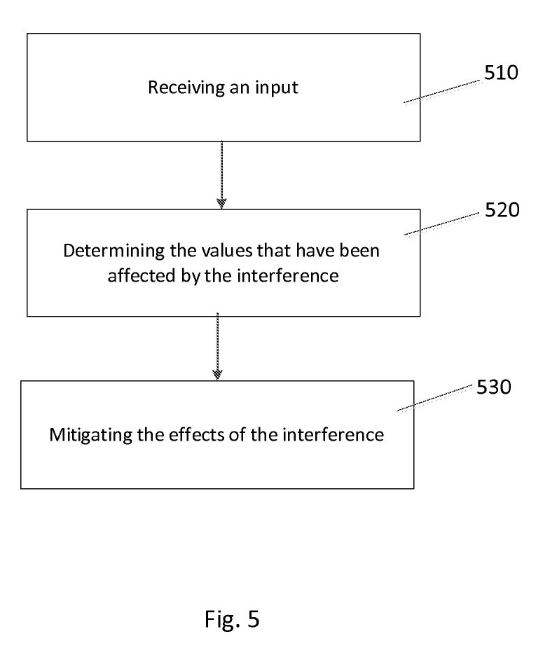

FIG. 5 illustrates a logic flow diagram of a method according to certain embodiments of the invention. The method illustrated in FIG. 5 may comprise, at 510, receiving, by a receiver, an input. The input may comprise a plurality of values. The receiver may receive the input in the presence of interference caused by another system. The method may also include, at 520, determining the values that have been affected by the interference. The method may also include, at 530, mitigating the effects of the interference upon the received input.

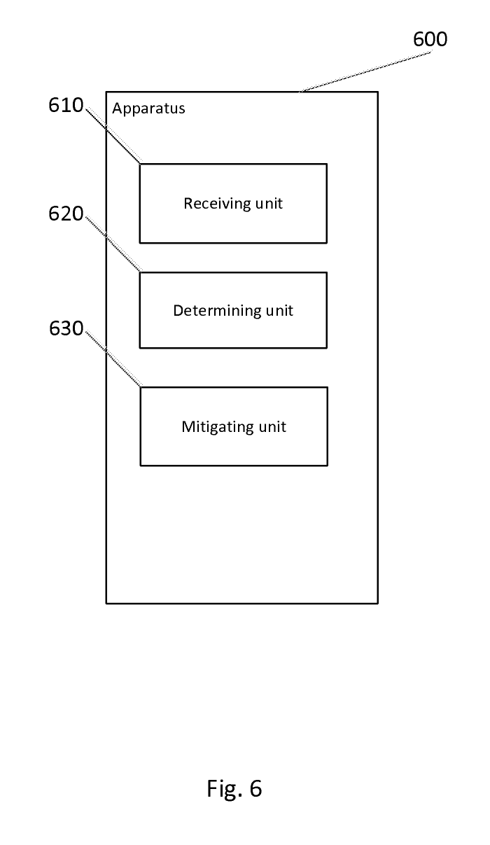

FIG. 6 illustrates an apparatus in accordance with one embodiment. Apparatus 600 may comprise a receiving unit 610 that receives an input. The input comprises a plurality of values. The receiving unit 610 receives the input in the presence of interference caused by another system. Apparatus 600 may also include a determining unit 620 that determines the values that have been affected by the interference. Apparatus 600 also includes a mitigating unit 630 that mitigates the effects of the interference upon the received input.

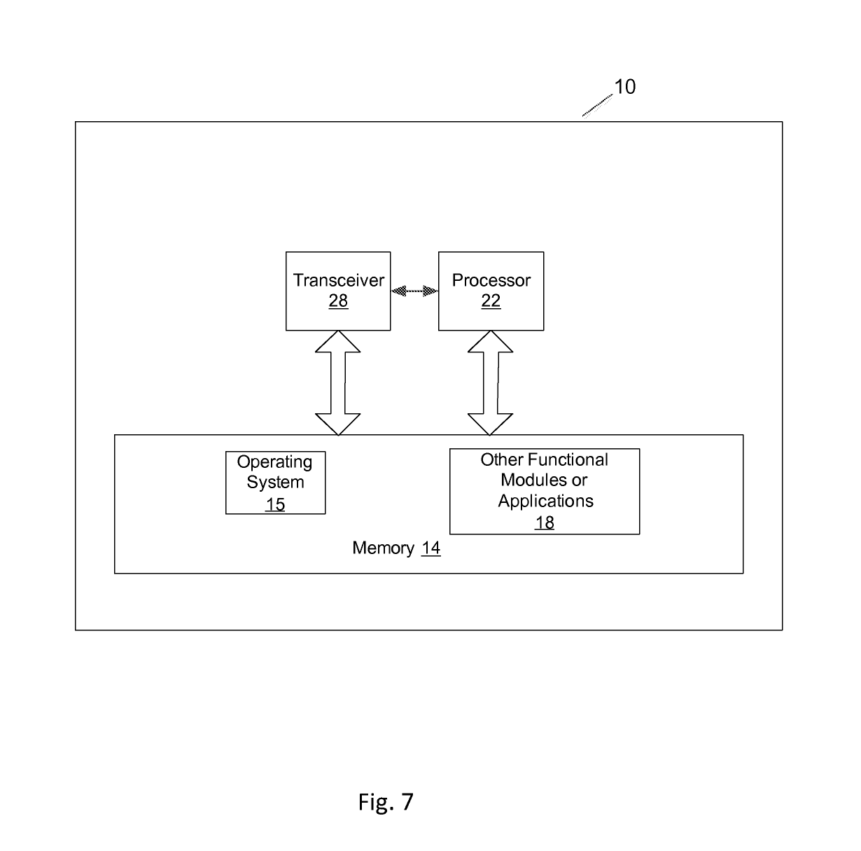

FIG. 7 illustrates an apparatus 10 according to embodiments of the invention. Apparatus 10 may be a device, such as a decoder and/or receiver, for example. In other embodiments, apparatus 10 may be a base station and/or access point, for example.

Apparatus 10 may comprise a processor 22 for processing information and executing instructions or operations. Processor 22 may be any type of general or specific purpose processor. While a single processor 22 is shown in FIG. 7, multiple processors may be utilized according to other embodiments. Processor 22 may also comprise one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further comprise a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may comprise program instructions or computer program code that, when executed by processor 22, enable the apparatus 10 to perform tasks as described herein.

Apparatus 10 may also comprise one or more antennas (not shown) for transmitting and receiving signals and/or data to and from apparatus 10. Apparatus 10 may further comprise a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 comprising, without limitation, precoding of antenna gain/phase parameters, encoding and decoding of individual bits forming a communication message, formatting of information, and overall control of the apparatus 10, comprising processes related to management of communication resources.

In certain embodiments, memory 14 stores software modules that provide functionality when executed by processor 22. The modules may comprise an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
receiving, by a receiver, an input, wherein the input comprises a plurality of values, and the receiver receives the input in the presence of interference caused by another system;
determining the values that have been affected by the interference; and
mitigating the effects of the interference upon the received input.

2. The method according to claim 1, wherein the interference is caused by a radar system.

3. The method according to claim 1, wherein receiving the values comprises receiving at least one of log likelihood ratios, soft decisions, I/Q values, pre-equalization values, post-equalization values, pre-Fast-Fourier-Transform values, post-Fast-Fourier-Transform values, and post-processing values.

4. The method according to claim 1, wherein the determining the values that have been affected by the interference comprises determining values that are abnormal.

5. The method according to claim 1, wherein the determining the values that have been affected by the interference comprises calculating an average value and a standard deviation of the values.

6. The method according to claim 1, wherein the determining the values that have been affected by the interference comprises comparing the values to a threshold.

7. The method according to claim 1, wherein the mitigating the effects of the interference comprises replacing the values that have been determined to have been affected by the interference.

8. The method according to claim 7, wherein the replacing the values comprises replacing the values with zeros.

9. An apparatus, comprising:
at least one processor; and
at least one memory including computer program code,
the at least one memory and the computer program code configured, with the at least one processor, to cause the apparatus at least to
receive an input, wherein the input comprises a plurality of values, and the apparatus receives the input in the presence of interference caused by another system;
determine the values that have been affected by the interference; and
mitigate the effects of the interference upon the received input.

10. The apparatus according to claim 9, wherein the interference is caused by a radar system.

11. The apparatus according to claim 9, wherein receiving the values comprises receiving at least one of log likelihood ratios, soft decisions, I/Q values, pre-equalization values, post-equalization values, pre-Fast-Fourier-Transform values, post-Fast-Fourier-Transform values, and post-processing values.

12. The apparatus according to claim 9, wherein the determining the values that have been affected by the interference comprises determining values that are abnormal.

13. The apparatus according to claim 9, wherein the determining the values that have been affected by the interference comprises calculating an average value and a standard deviation of the values.

14. The apparatus according to claim 9, wherein the determining the values that have been affected by the interference comprises comparing the values to a threshold.

15. The apparatus according to claim 9, wherein the mitigating the effects of the interference comprises replacing the values that have been determined to have been affected by the interference.

16. The apparatus according to claim 15, wherein the replacing the values comprises replacing the values with zeros.

17. A computer program product, embodied on a non-transitory computer readable medium, the computer program product configured to control a processor to perform a process comprising:
receiving, by a receiver, an input, wherein the input comprises a plurality of values, and the receiver receives the input in the presence of interference caused by another system;
determining the values that have been affected by the interference; and
mitigating the effects of the interference upon the received input.

18. The computer program product of claim 17, wherein the interference is caused by a radar system.

19. The computer program product of claim 17, wherein receiving the values comprises receiving at least one of log likelihood ratios, soft decisions, I/Q values, pre-equalization values, post-equalization values, pre-Fast-Fourier-Transform values, post-Fast-Fourier-Transform values, and post-processing values.

20. The computer program product of claim 17, wherein the determining the values that have been affected by the interference comprises determining values that are abnormal.
